(19) United States
(12) Patent Application Publication
(10) Pub. No.: US 2019/0077467 A1
(43) Pub. Date: Mar. 14, 2019

(54) CAB LOCKING DEVICE OF TRUCK

(71) Applicants: HYUNDAI MOTOR COMPANY, Seoul (KR); KIA Motors Corporation, Seoul (KR)

(72) Inventors: Gi Yong Lee, Jeonju-si (KR); Tae Jin Hwang, Jeonju-si (KR); Jee Eung Lee, Iksan-si (KR)

(73) Assignees: HYUNDAI MOTOR COMPANY, Seoul (KR); KIA Motors Corporation, Seoul (KR)

(21) Appl. No.: 15/804,368

(22) Filed: Nov. 6, 2017

(30) Foreign Application Priority Data
Sep. 11, 2017 (KR) 10-2017-0116032

(51) Int. Cl. B62D 33/07

(52) U.S. Cl. CPC B62D 33/071

(57) ABSTRACT

Disclosed is a cab locking device of a truck. The cab locking device includes a latch and a striker. The latch is mounted on a frame that is close to a vehicle body of the truck. The striker is mounted on a cab that is hinge-coupled to the frame to be tilted. The striker includes a body mounted on the cab, a locking pin mounted on the body to be selectively locked or unlocked by the latch according to whether the cab is tilted, and an impact absorbing cushion disposed between the latch and the body to maintain an interval between the body and the latch.

### CROSS-REFERENCE TO RELATED APPLICATION

This application is based on and claims the benefit of priority to Korean Patent Application No. 10-2017-0116032, filed on Sep. 11, 2017, in the Korean Intellectual Property Office, the disclosure of which is incorporated herein in its entirety by reference.

### TECHNICAL FIELD

The present disclosure relates to a cab locking device of a truck.

### BACKGROUND

In general, a truck is provided such that a cab, in which a driver's seat and a passenger seat are provided, may be tilted to the front side of the vehicle body of the truck.

Meanwhile, the cab is provided with a striker to be locked or unlocked by using a latch provided in the vehicle body.

The striker also remains locked by the latch while the cab is coupled to the vehicle body, and the striker is unlocked from the latch such that the cab may be tilted away from the vehicle body.

Because the coupling of the cab and the vehicle body is directly related to safety in the conventional truck, the striker and the latch are mainly formed of a metal material. Due to this, in the conventional truck, when the cab is tilted up or tilted down, frictional noise is generated by the contact of the striker and the latch. The noise negatively affects the product value.

### SUMMARY

The present disclosure is conceived to solve the above-described problems of the related art, and the present disclosure provides a cab locking device of a truck that has an improved structure to prevent frictional noise from being generated between a striker and a latch when a cab is tilted.

The technical objects of the present disclosure are not limited to the above-mentioned one, and the other unmentioned technical objects will become apparent to those skilled in the art from the following description.

In accordance with an aspect of the present disclosure, there is provided a cab locking device of a truck including a latch mounted on a frame of a vehicle body of the truck, and a striker mounted on a cab that is hinge-coupled to the frame, the cab being capable of being tilted, wherein the striker includes a body mounted on the cab, a locking pin mounted on the body to be selectively locked or unlocked by the latch according to whether the cab is tilted, and an impact absorbing cushion disposed between the latch and the body to maintain an interval between the body and the latch.

It is preferable that the locking pin be installed such that the latch is coupled to a predetermined location of the locking pin and the impact absorbing cushion be disposed between the predetermined location of the locking pin and the body.

It is preferable that the impact absorbing cushion have a conic shape, a diameter of an outer periphery of which gradually increases from the predetermined location of the locking pin toward the body.

It is preferable that the impact absorbing cushion include an insertion hole into which the locking pin may be inserted.

It is preferable that the impact absorbing cushion further include at least one chamber provided between the insertion hole and the outer periphery of the conic shape.

It is preferable that one of the body and the impact absorbing cushion include a stopper recess formed at a predetermined location thereof and the other of the body and the impact absorbing cushion includes a stopper boss formed to be stopped by the stopper recess.

It is preferable that the body include a first fixing plate mounted on the cab, and a second fixing plate disposed to be spaced apart from the first fixing plate by a predetermined interval.

It is preferable that the first fixing plate include a first through-hole such that one end of the locking pin is inserted into the first through-hole and the second fixing plate includes a second through-hole such that an opposite end of the locking pin is inserted into the second through-hole.

It is preferable that one end of the locking pin be supported by the first fixing plate and an opposite end of the locking pin is supported by the second fixing plate.

It is preferable that one end of the locking pin include a flange for preventing the one end of the locking pin from passing through the first through-hole.

It is preferable that the striker further include a fixing ring that is coupled to an opposite end of the locking pin for preventing the opposite end of the locking pin from being removed from the second through-hole.

It is preferable that a diameter of the fixing ring is larger than a diameter of the second through-hole, thus preventing the fixing ring from entering the second through-hole.

It is preferable that the impact absorbing cushion be formed of a material, a hardness of which is lower than that of the body.

It is preferable that the body and the locking pin be formed of a metal material and the impact absorbing cushion is formed of a plastic material.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a main part of a truck, to which a cab locking device according to the present disclosure is applied;

FIG. 2 is a view illustrating a cab locking device of a truck according to an embodiment of the present disclosure;

FIG. 3 is a view illustrating a latch of the cab locking device depicted in FIG. 2;

FIG. 4 is a sectional view illustrating the latch depicted in FIG. 3;

FIG. 5 is a view illustrating a striker of the cab locking device depicted in FIG. 2;

FIG. 6 is an exploded view illustrating the striker depicted in FIG. 5; and

FIG. 7 is a view illustrating a state in which the striker is locked by the latch in the cab locking device depicted in FIG. 2.

### DETAILED DESCRIPTION

Hereinafter, exemplary embodiments of the present disclosure will be described in detail with reference to the accompanying drawings. Throughout the specification, it is noted that the same or like reference numerals denote the same or like components even though they are provided in different drawings. Further, in the following description of the present disclosure, a detailed description of known functions and configurations incorporated herein will be omitted when it may make the subject matter of the present disclosure unclear.

In addition, terms such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

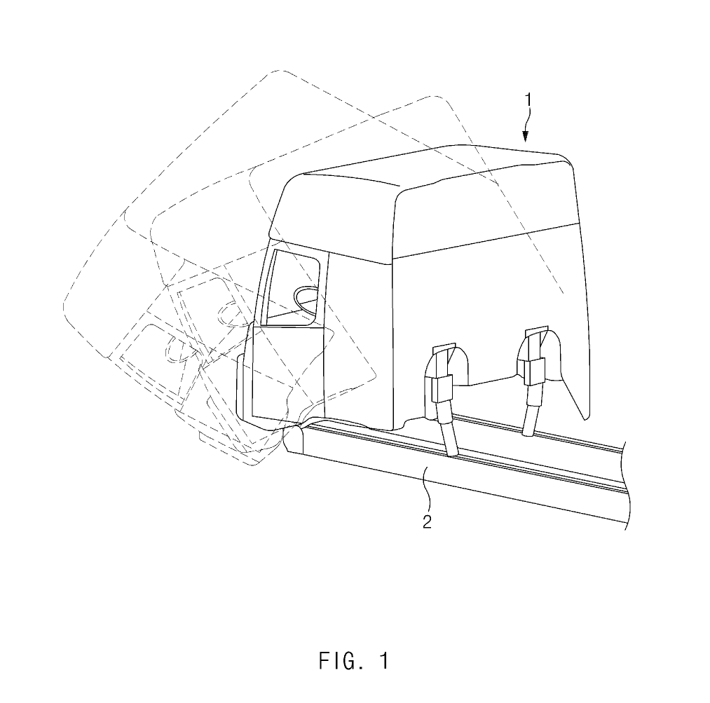

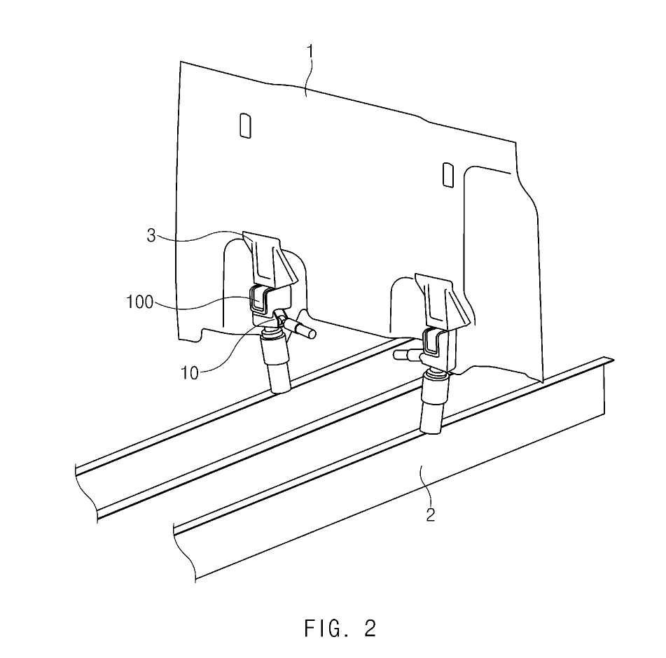

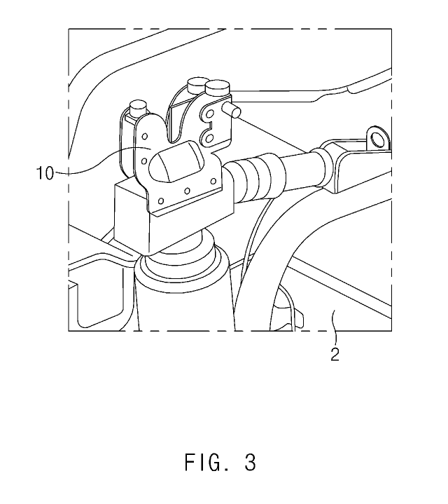

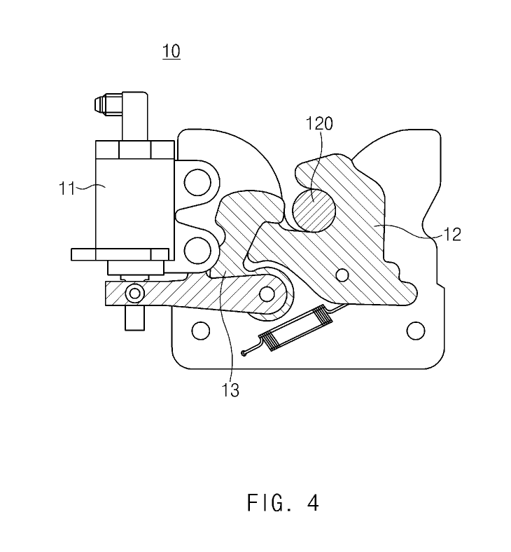

FIG. 1 is a view illustrating a main part of a truck, to which a cab locking device according to the present disclosure is applied. FIG. 2 is a view illustrating a cab locking device of a truck according to an embodiment of the present disclosure. FIG. 3 is a view illustrating a latch of the cab locking device depicted in FIG. 2. FIG. 4 is a sectional view illustrating the latch depicted in FIG. 3.

As illustrated in FIGS. 1 and 2, the cab locking device of a truck according to the present disclosure may include a latch 10 mounted to a vehicle body of the truck, and a striker 100 mounted to a cab 1 coupled to the vehicle body to be tilted.

First, the cab 1 is a member that is hinge-coupled to the frame 2 of the vehicle body to be tilted, and is tilted up to the front side of the vehicle body when an engine or the like of the vehicle is maintained and repaired, and is tilted down to be restored to the original state after the maintenance.

Here, the cab 1 may be automatically tilted by a tilting device (not illustrated). The tilting device (not illustrated) includes a cylinder installed in the frame 2, and a piston installed in the cab 1 to be linearly reciprocated by the cylinder. The tilting device may tilt the cab 1 while the piston is moved by a hydraulic pressure of the cylinder.

The cab 1 may include a connection member 3 having a bracket structure that connects a body 110 of the striker 100, which will be described below, and the cab 1.

Next, the latch 10 is a member that is mounted on the frame 2 such that the striker 100, which will be described below may be locked or unlocked as illustrated in FIGS. 2 and 3.

As illustrated in FIG. 4, the latch 10 includes a hydraulic cylinder 11, a hook 12, and a pole 13. The hydraulic cylinder 11 is expanded or contracted by a hydraulic pressure supplied from a hydraulic mechanism (not illustrated) provided in the frame 2. The hook 12 locks or unlocks a locking pin 120 of the striker 100, which will be described below, through rotation thereof. The pole 13 rotates the hook 12 while rotating in a specific direction through the expansion or contraction of the hydraulic cylinder 11.

One or more latches 10 may be mounted on the frame 2 to be rotated. The cab 1 may be fixed to or unfixed from the frame 2 of the vehicle body by locking or unlocking the locking pin 120 of the striker 100 through the hook 12.

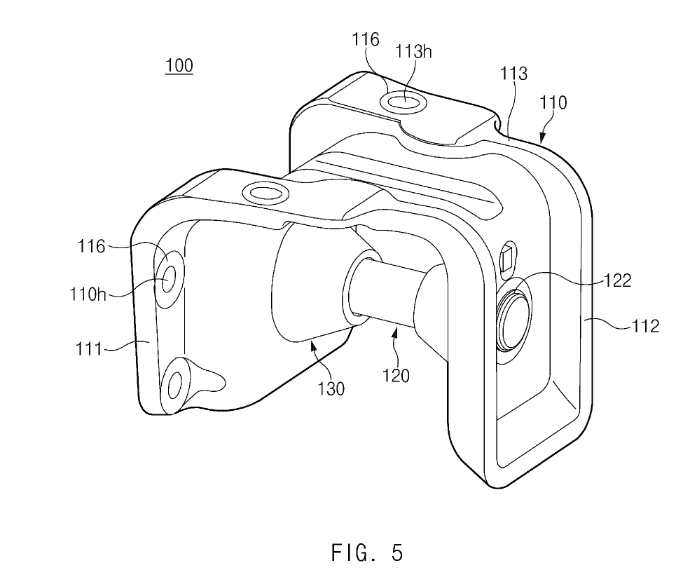

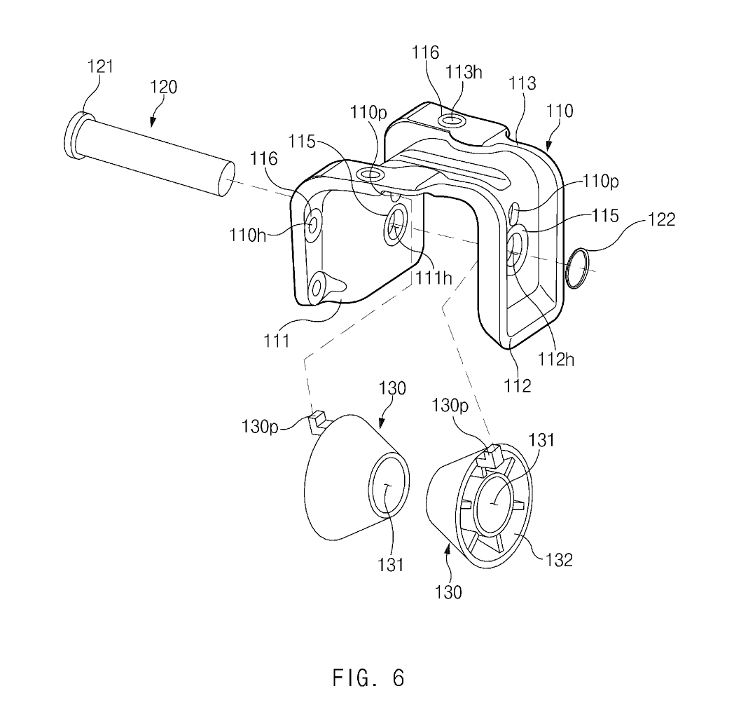

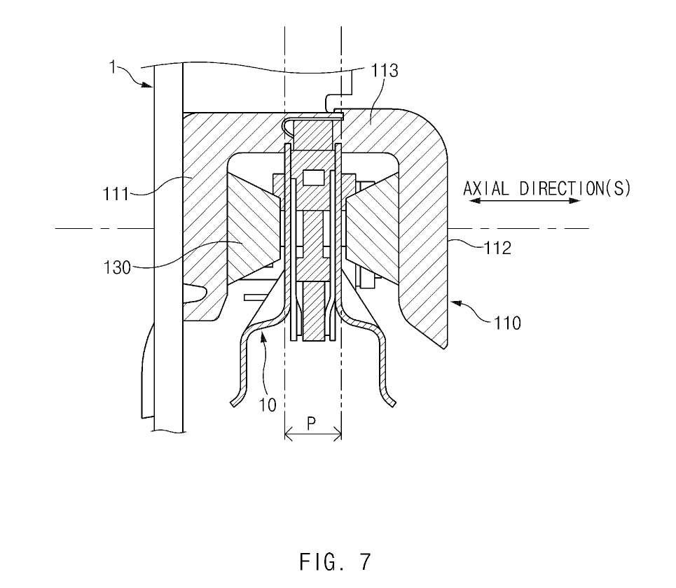

FIG. 5 is a view illustrating a striker of the cab locking device depicted in FIG. 2. FIG. 6 is an exploded view illustrating the striker depicted in FIG. 5. FIG. 7 is a view illustrating a state in which the striker is locked by the latch in the cab locking device depicted in FIG. 2.

Next, the striker 100 may be unlocked from the latch 10 if the cab 1 is tilted up, and one or more strikers 100 are mounted on the cab 1 to be locked by the latch 10 when the cab 1 is tilted down.

The structure of the striker 100 is not specifically limited. For example, the striker 100 may include a body 110, a locking pin 120 mounted on the body 110, and an impact absorbing cushion 130 provided in the locking pin 120.

First, the body 110 is mounted on the cab 1, and forms an external appearance of the striker 100.

The body 110 includes a first fixing plate 111 mounted on the cab 1, a second fixing plate 112 disposed to be spaced apart from the first fixing plate 111 by a predetermined interval, and a connection plate 113 that connects the first fixing plate 111 and the second fixing plate 112.

Because one end of the first fixing plate 111 and one end of the second fixing plate 112 are connected to each other by the connection plate 113 while the first fixing plate 111 and the second fixing plate 112 are disposed in parallel to each other, an opposite end of the first fixing plate 111 and an opposite end of the second fixing plate 112 are opened so that the body 110 has a stapler shape.

The first fixing plate 111 includes a first through-hole 111h that is punched such that one end of the locking pin 120, which will be described below, may be inserted into the first through-hole 111h. The second fixing plate 112 includes a second through-hole 112h that is punched such that an opposite end of the locking pin 120 may be inserted into the second through-hole 112h.

It is preferable that a movement preventing member 115 be provided on the inner peripheral surfaces of the first through-hole 111h and the second through-hole 112h according to the outer diameter of the locking pin 120. The movement preventing members 115 prevent movement of the locking pin 120 inserted into the first through-hole 111h and the second through-hole 112h.

One of the first fixing plate 111 or the second fixing plate 112 includes one or more first coupling holes 110h formed at a predetermined location to be coupled to the cab 1. It is preferable that one surface (the first fixing plate 111 or the second fixing plate 112) of the body 110 be fixedly coupled to the cab 1 through a separate coupling unit, such as a bolt.

The connection plate 113 includes one or more second coupling holes 113h formed at a predetermined location to be coupled to the connection member 3. It is preferable that an opposite surface (the connection plate 113) of the body 110 be fixedly coupled to the connection member through a separate coupling unit, such as a bolt.

It is preferable that inner peripheral surfaces of the first coupling hole 110h and the second coupling hole 113h include a coupling member 116 to improve the fixing force when the cab 1 or the connection member 3 and the body 110 are coupled to each other.

Next, the locking pin 120 has a shaft shape. The latch 10 is installed in the body 110 to be coupled to a predetermined location of the locking pin 120. The cab 1 is selectively locked or unlocked by the latch 10 according to whether the cab 1 is tilted.

One end of the locking pin 120 is fixedly supported by the first fixing plate 111, and an opposite end of the locking pin 120 is fixedly supported by the second fixing plate 112.

A flange 121 is formed at one end of the locking pin 120 for preventing the one end of the locking pin 120 from going through the first through-hole 111h. The flange 121 may prevent the locking pin 120 from deviating through the first through-hole 111h after the locking pin 120 is inserted into the first through-hole 111h.

An O-ring-shaped fixing ring 122 is mounted in the second through-hole 112h. The fixing ring 122 is installed on an outer peripheral surface of the opposite end of the locking pin 120 that passes through the second through-hole 112h to fix the opposite end of the locking pin 120 to the second fixing plate 112 and prevent the opposite end of the locking pin 120 from being removed from the second through-hole.

The diameter of the fixing ring 122 is larger than the diameter of the second through-hole 112h, thus preventing the ring 122 from entering the second through-hole 112h. Accordingly, the opposite end of the locking pin 120 is fixed to the second fixing plate 112.

Next, the impact absorbing cushion 130 is disposed between the latch 10 and the body 110. In a more detailed description of the impact absorbing cushion 130, the latch 10 is disposed between a proper location P (see FIG. 7) of the locking pin 120 and the body 110. The impact absorbing cushion 130 may maintain an interval between the latch 10 and the body 110.

The impact absorbing cushion 130 is provided on the locking pin 120 to restrain the latch 10 from moving along an axial direction S of the locking pin 120, thereby preventing frictional noise generated when the latch 10 moves along the axial direction S of the locking pin 120.

One or more impact absorbing cushions 130 are provided, and have a conic shape. The diameter of an outer periphery of each cushion gradually increases as it goes from the proper location P toward the body 110.

The impact absorbing cushion 130 includes an insertion hole 131 that is punched such that the locking pin 120 is inserted into the insertion hole 131.

Further, it is preferable that the impact absorbing cushion 130 further includes at least one chamber 132 provided between the insertion hole 131 and the outer periphery of the impact absorbing cushion 130. The chamber 132 may reduce the weight of the impact absorbing cushion 130, and may reduce noise by absorbing noise generated by a locking or unlocking operation of the latch 10 and the locking pin 120.

Meanwhile, because the impact absorbing cushion 130 has to be located on inner surfaces of the first fixing plate 111 and the second fixing plate 112 of the body 110, it is preferable that the impact absorbing cushion 130 be fixed to the body 110 first when the locking pin 120 is installed in the body 110.

To achieve this, one of the body 110 and the impact absorbing cushion 130 may include a stopper recess 110p formed at a predetermined location thereof, and the other of the body 110 and the impact absorbing cushion 130 may include a stopper boss 130p formed to be stopped by the stopper recess 110p. Although it will be described below for convenience of description, as illustrated in the drawings, that the body 110 includes the stopper recess 110p and the impact absorbing cushion 130 includes the stopper boss 130p, the present disclosure is not limited thereto.

The impact absorbing cushion 130 maintains a state in which the stopper boss 130p of the impact absorbing cushion 130 is inserted into the stopper recess 110p of the body 110 and the locking pin 120 is coupled to the stopper recess 110p. Thereafter, by inserting the locking pin 120 into the body 110 while the stopper boss 130p is coupled to the stopper recess 110p, the assembly of the striker 100 may be completed.

Further, it is preferable that the impact absorbing cushion 130 be formed of a material, a hardness of which is lower than that of the body 110.

In more detail, it is preferable that the body 110 and the locking pin 120 be formed of a metal material and the impact absorbing cushion 130 be formed of a plastic material.

When the latch 10 and the locking pin 120 of metal materials are locked or unlocked, noise is generated due to the contact of the metal materials. The plastic material of the impact absorbing cushion 130 provided on the locking pin 120 restricts movement of the latch 10 such that the latch 10 cannot move along the locking pin 120 through the impact absorbing cushion 130 during driving of the vehicle, thereby reducing noise by minimizing the contact of the locking pin 120 and the latch 10.

A sequence of assembling the striker 100 of the cab locking device of a truck according to the present disclosure will be described below.

First, the impact absorbing cushion 130 is located such that the diameter of the outer periphery of the impact absorbing cushion 130 gradually increases as it goes from a proper location P of the locking pin 120 coupled to the latch 10 toward the body 110 when the body 110 and the impact absorbing cushion 130 are coupled to each other

Next, the body 110 and the cushion 130 are coupled to each other by inserting the stopper boss 130p provided in the impact absorbing cushion 130 into the stopper recess 110p provided in the body 110.

Next, the locking pin 120 is inserted through the first through-hole 111h and the second through-hole 112h of the body 110, and the flange 121 formed at one end of the locking pin 120 is stopped by the first through-hole 111h.

Finally, the assembly of the striker 100 is completed by mounting the fixing ring 122 on the opposite end of the locking pin 120 and fixing the locking pin 120 to the body 110.

The cab locking device of a truck according to the present disclosure may restrict movement of the latch such that the latch cannot move along the locking pin of the striker, thereby improving the product value by preventing the generation of noise between the striker and the latch.

The above description is a simple exemplification of the technical spirit of the present disclosure, and the present disclosure may be variously corrected and modified by those skilled in the art to which the present disclosure pertains without departing from the essential features of the present disclosure.

Therefore, the disclosed embodiments of the present disclosure do not limit the technical spirit of the present disclosure but are illustrative, and the scope of the technical spirit of the present disclosure is not limited by the embodiments of the present disclosure. The scope of the present disclosure should be construed by the claims, and it will be understood that all the technical spirits within the equivalent range fall within the scope of the present disclosure.

What is claimed is:

1. A cab locking device of a truck comprising:
a latch mounted on a frame of a vehicle body of the truck; and
a striker mounted on a cab that is hinge-coupled to the frame, the cab being capable of being tilted,
wherein the striker includes:
a body mounted on the cab;
a locking pin mounted on the body to be selectively locked or unlocked by the latch according to whether the cab is tilted; and
an impact absorbing cushion disposed between the latch and the body to maintain an interval between the body and the latch.

2. The cab locking device of claim 1, wherein the locking pin is installed such that the latch is coupled to a predetermined location of the locking pin, and
wherein the impact absorbing cushion is disposed between the predetermined location of the locking pin and the body.

3. The cab locking device of claim 2, wherein the impact absorbing cushion has a conic shape, a diameter of an outer periphery of which gradually increases from the predetermined location of the locking pin toward the body.

4. The cab locking device of claim 3, wherein the impact absorbing cushion includes:
an insertion hole into which the locking pin may be inserted.

5. The cab locking device of claim 4, wherein the impact absorbing cushion further includes:
at least one chamber provided between the insertion hole and the outer periphery of the conic shape.

6. The cab locking device of claim 1, wherein one of the body and the impact absorbing cushion includes a stopper recess formed at a predetermined location thereof, and
wherein the other of the body and the impact absorbing cushion includes a stopper boss formed to be stopped by the stopper recess.

7. The cab locking device of claim 1, wherein the body includes:
a first fixing plate mounted on the cab; and
a second fixing plate disposed to be spaced apart from the first fixing plate by a predetermined interval.

8. The cab locking device of claim 7, wherein the first fixing plate includes:
a first through-hole such that one end of the locking pin is inserted into the first through-hole, and
wherein the second fixing plate includes:
a second through-hole such that an opposite end of the locking pin is inserted into the second through-hole.

9. The cab locking device of claim 7, wherein one end of the locking pin is supported by the first fixing plate and an opposite end of the locking pin is supported by the second fixing plate.

10. The cab locking device of claim 9, wherein one end of the locking pin includes a flange for preventing the one end of the locking pin from passing through the first through-hole.

11. The cab locking device of claim 10, wherein the striker further includes:
a fixing ring that is coupled to an opposite end of the locking pin for preventing the opposite end of the locking pin from being removed from the second through-hole.

12. The cab locking device of claim 11, wherein a diameter of the fixing ring is larger than a diameter of the second through-hole, thus preventing the fixing ring from entering the second through-hole.

13. The cab locking device of claim 1, wherein the impact absorbing cushion is formed of a material, a hardness of which is lower than that of the body.

14. The cab locking device of claim 13, wherein the body and the locking pin are formed of a metal material and the impact absorbing cushion is formed of a plastic material.
